(19) United States
(12) Patent Application Publication
(10) Pub. No.: US 2026/0163089 A1
(43) Pub. Date: Jun. 11, 2026

(54) BATTERY PACK

(71) Applicant: TOYOTA JIDOSHA KABUSHIKI KAISHA, Toyota-shi (JP)

(72) Inventor: Shoichiro MORINAKA, Toyota-shi (JP)

(73) Assignee: TOYOTA JIDOSHA KABUSHIKI KAISHA, Toyota-shi (JP)

(21) Appl. No.: 19/395,997

(22) Filed: Nov. 20, 2025

(30) Foreign Application Priority Data
Dec. 11, 2024 (JP) 2024-217093

(51) Int. Cl. H01M 10/48; H01M 50/249

(52) U.S. Cl. CPC H01M 10/482; H01M 50/249

(57) ABSTRACT

A battery pack includes a plurality of battery stacks, a voltage monitoring device, a bracket, and a case. The case includes an upper case and a lower case. The lower case includes a lower case body and a cross member. The battery stacks are disposed to avoid the cross member when viewed from above. The bracket is fixed to an upper surface portion of the cross member, and an upper surface of the bracket is located above upper surfaces of the battery stacks.

### CROSS-REFERENCE TO RELATED APPLICATION

This application claims priority to Japanese Patent Application No. 2024-217093 filed on Dec. 11, 2024. The disclosure of the above-identified application, including the specification, drawings, and claims, is incorporated by reference herein in its entirety.

### BACKGROUND

### 1. Technical Field

The present disclosure relates to a battery pack.

### 2. Description of Related Art

Japanese Unexamined Patent Application Publication No. 2020-113528 (JP 2020-113528 A) discloses a battery pack including a battery stack and a case. The battery pack further includes a support member that supports an upper case from the back surface side. This is intended to suppress vibration of the upper case.

### SUMMARY

An object of the present disclosure is to achieve, in a battery pack including a battery stack and a case, appropriate protection of the battery stack against a load input from above while securing a mounting space for the battery stack.

A battery pack according to a first aspect includes: a plurality of battery stacks; a voltage monitoring device; a bracket that supports the voltage monitoring device; and a case that houses the battery stacks, the voltage monitoring device, and the bracket. The case includes an upper case and a lower case. The lower case includes a lower case body and a cross member. The battery stacks are disposed to avoid the cross member when viewed from above. The bracket is fixed to an upper surface portion of the cross member. An upper surface of the bracket is located above upper surfaces of the battery stacks.

The present aspect relates to the battery pack. The battery pack includes the battery stacks, the voltage monitoring device, the bracket that supports the voltage monitoring device, and the case that houses these components. The case includes the upper case and the lower case. The lower case includes the lower case body and the cross member. The battery stacks are disposed to avoid the cross member when viewed from above.

If an attempt is made to increase the ratio of the mounting space for the battery stacks within the case, it is difficult to provide, at appropriate positions, the members (intermediate mount or intermediate bracket) for preventing deformation of the upper case due to a load input from above. In the present aspect, the bracket is fixed to the upper surface portion of the cross member, and the upper surface of the bracket is located above the upper surface of the battery stack. Therefore, the bracket that supports the voltage monitoring device can serve as the intermediate mount. According to the present aspect, it is possible to achieve appropriate protection of the battery stacks against the load input from above while securing the mounting space for the battery stacks.

Since the object of the present aspect is to protect the battery stacks against the load input from above and not to suppress vibration of the upper case, the upper surface of the bracket need not be in contact with the back surface of the upper case.

In an embodiment described later, a first direction is a vehicle front-rear direction and a second direction is a vehicle width direction, but the present aspect is not limited to this.

In a battery pack according to a second aspect, in the first aspect, the bracket is made of metal, the bracket and the voltage monitoring device are joined by welding, and the bracket and the cross member are fastened by a fastening member.

In the present aspect, the bracket is made of metal. The bracket and the voltage monitoring device are joined by welding, and the bracket and the cross member are fastened by the fastening member. Compared to a form in which the bracket is made of resin, the battery stacks can be protected appropriately even if the amount of protrusion from the upper surfaces of the battery stacks (amount of protrusion of the bracket) is small. Further, the voltage monitoring device can be supported appropriately and the load can be transmitted effectively to the cross member.

In a battery pack according to a third aspect, in the first or second aspect, when directions perpendicular to a vehicle up-down direction and perpendicular to each other are defined as a first direction and a second direction, the cross member extends along the second direction, upper support portions constituting the upper surface of the bracket include: a one-side upper support portion; and an other-side upper support portion, and the one-side upper support portion and the other-side upper support portion are located at positions separated from each other in the second direction.

In the present aspect, when directions perpendicular to the vehicle up-down direction and perpendicular to each other are defined as the first direction and the second direction, the cross member extends along the second direction. The upper support portions constituting the upper surface of the bracket include the one-side upper support portion and the other-side upper support portion. The one-side upper support portion and the other-side upper support portion are located at positions separated from each other in the second direction. Therefore, the bracket for the voltage monitoring device can support the upper case at two points separated from each other in the second direction.

In a battery pack according to a fourth aspect, in any one of the first to third aspects, when directions perpendicular to a vehicle up-down direction and perpendicular to each other are defined as a first direction and a second direction, the cross member extends along the second direction, two of the battery stacks are arranged in the second direction, the battery pack includes an intermediate mount including an upper surface located above the upper surfaces of the battery stacks, and the bracket or the intermediate mount is located at a position offset in the second direction from a center in the second direction within the case.

In the present aspect, when directions perpendicular to the vehicle up-down direction and perpendicular to each other are defined as the first direction and the second direction, the cross member extends along the second direction. Two of the battery stacks are arranged in the second direction. Therefore, the size of each battery stack can be increased in the second direction compared to a form in which three or more battery stacks are arranged in the second direction. However, the intermediate bracket connecting the battery stacks in the second direction cannot function to suppress deformation of the upper case at a position offset in the second direction from the center of the case in the second direction. In the present aspect, the battery pack includes the intermediate mount including the upper surface located above the upper surfaces of the battery stacks. The bracket or the intermediate mount is located at a position offset in the second direction from the center in the second direction within the case. Therefore, the bracket for the voltage monitoring device or the intermediate mount can suppress deformation of the upper case at a position offset in the second direction from the center of the case in the second direction.

In the embodiment described later, the battery pack includes an intermediate bracket that fastens two battery stacks adjacent in the second direction, and the upper surface of the intermediate bracket is located above the upper surfaces of the battery stacks. However, the present aspect is not limited to this.

In a battery pack according to a fifth aspect, in any one of the first to third aspects, when directions perpendicular to a vehicle up-down direction and perpendicular to each other are defined as a first direction and a second direction, the cross member extends along the second direction, two of the battery stacks are arranged in the second direction, and the bracket is located at a position offset in the second direction from a center in the second direction within the case.

In the present aspect, when directions perpendicular to the vehicle up-down direction and perpendicular to each other are defined as the first direction and the second direction, the cross member extends along the second direction. Two of the battery stacks are arranged in the second direction. Therefore, the size of each battery stack can be increased in the second direction compared to a form in which three or more battery stacks are arranged in the second direction. However, the intermediate bracket connecting the battery stacks in the second direction cannot function to suppress deformation of the upper case at a position offset in the second direction from the center of the case in the second direction. In the present aspect, the bracket is located at a position offset in the second direction from the center in the second direction within the case. Therefore, the bracket for the voltage monitoring device can suppress deformation of the upper case at a position offset in the second direction from the center of the case in the second direction.

In the embodiment described later, the battery pack includes an intermediate bracket that fastens two battery stacks adjacent in the second direction, and the upper surface of the intermediate bracket is located above the upper surfaces of the battery stacks. However, the present aspect is not limited to this.

As described above, according to the present disclosure, it is possible to achieve appropriate protection of the battery stack against the load input from above while securing the mounting space for the battery stack.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional perspective view of a battery pack with an upper case omitted; and

FIG. 2 is a sectional view of the battery pack.

### DETAILED DESCRIPTION OF EMBODIMENTS

A battery pack 10 according to an embodiment will be described below.

Arrow FR shown in the drawings as appropriate indicates a vehicle front side, arrow UP indicates a vehicle upper side, and arrow LH indicates a left side in a vehicle width direction, respectively. Terms regarding directions of front-rear, up-down, and right-left when used in the following description indicate front-rear in a vehicle front-rear direction, up-down in a vehicle up-down direction, and right-left in the vehicle width direction, unless specified otherwise.

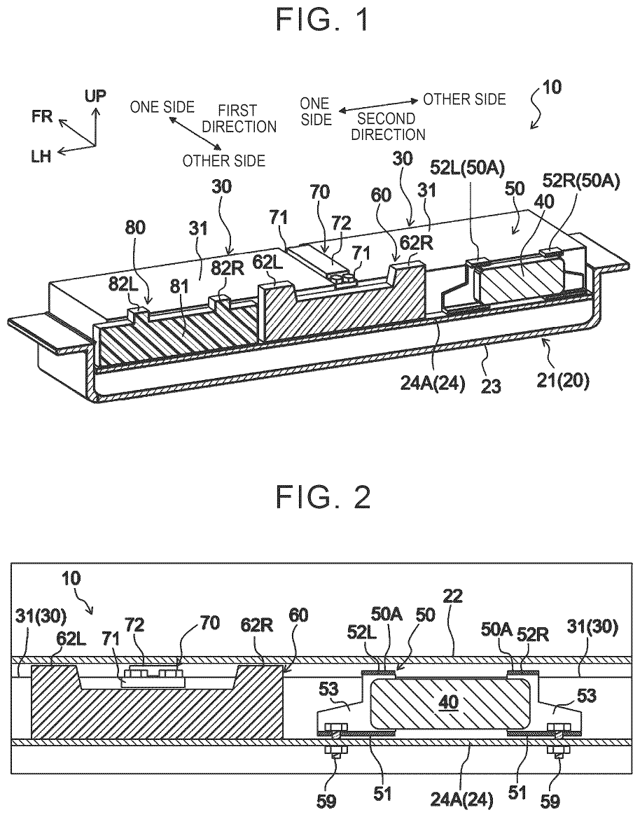

As shown in FIG. 1, directions perpendicular to the vehicle up-down direction and perpendicular to each other are defined as a first direction and a second direction. In the present embodiment, the vehicle front-rear direction corresponds to the first direction, and the vehicle width direction corresponds to the second direction.

The battery pack 10 of the present embodiment is a battery pack disposed under the floor of a vehicle. The battery pack 10 includes a case 20, a plurality of battery stacks 30 (battery modules), a voltage monitoring device 40, a bracket 50 that supports the voltage monitoring device 40, an intermediate mount 60, an intermediate bracket 70, and a heat insulating member 80.

The case 20 includes a lower case 21 and an upper case 22 (see FIG. 2).

The lower case 21 includes a lower case body 23 and a cross member 24 joined to the lower case body 23. The cross member 24 is a framework member that extends in the second direction. The cross member 24 together with the lower case body 23 forms a closed sectional structure that extends in the second direction. A plurality of cross members 24 is provided at intervals in the first direction.

The battery stacks 30 are disposed to avoid the cross members 24 when viewed from above. The battery stacks 30 are arranged side by side in the first direction and also in the second direction. Specifically, two battery stacks 30 are arranged in the second direction. For example, three or more battery stacks 30 are arranged in the first direction. FIG. 1 shows only two battery stacks 30 disposed at the extremity of one side in the first direction among the plurality of battery stacks 30.

A clearance extending in the second direction is secured between two battery stacks 30 arranged in the second direction and another two battery stacks 30 adjacent to the two battery stacks 30 in the first direction. This clearance corresponds to the cross member 24. The voltage monitoring device 40, the bracket 50, the intermediate mount 60, and the heat insulating member 80 are disposed on the upper side of the cross member 24.

Specifically, the voltage monitoring device 40 is also called a satellite battery module (SBM). The voltage monitoring device 40 is connected to the battery stack 30 via a wire harness etc. The voltage monitoring device 40 acquires information indicating the state of the battery stack 30, such as a voltage, to monitor the battery stack 30.

The bracket 50 supports the voltage monitoring device 40, and is fixed to an upper surface portion 24A of the cross member 24. Specifically, the bracket 50 is made of metal, the bracket 50 and the voltage monitoring device 40 are joined by welding, and the bracket 50 and the cross member 24 are fastened by fastening members 59 (see FIG. 2).

As shown in FIG. 2, the bracket 50 includes fixing portions 51 fixed to the upper surface portion 24A of the cross member 24 by fastening, upper support portions 52L, 52R constituting the upper end of the bracket 50, and connecting portions 53 connecting the fixing portions 51 and the upper support portions 52L, 52R.

The bracket 50 is formed by, for example, bending a metal plate (e.g., an iron plate). The thickness direction of the fixing portion 51 approximately agrees with the up-down direction. The fixing portions 51 are fastened to the upper surface portion 24A of the cross member 24 by the fastening members 59 such as bolts and nuts. The thickness direction of the connecting portion 53 approximately agrees with the first direction. The connecting portions 53 support the voltage monitoring device 40. For example, the connecting portions 53 are welded to the voltage monitoring device 40 to support the voltage monitoring device 40. The thickness directions of the upper support portions 52L, 52R approximately agree with the up-down direction.

An upper surface 50A of the bracket 50 is located above an upper surface 31 of the battery stack 30. Specifically, the upper surfaces 50A of the upper support portions 52L, 52R are located above the upper surface 31 of the battery stack 30. That is, the upper surfaces 50A of the upper support portions 52L, 52R of the bracket 50 serve as the upper surface 50A of the bracket 50. The upper surface 31 of the battery stack 30 is the upper surface of a binding band for binding a plurality of battery cells constituting the battery stack 30 in a stacking direction (second direction in the present embodiment).

The upper support portions 52L, 52R include a one-side upper support portion 52L and an other-side upper support portion 52R. The one-side upper support portion 52L and the other-side upper support portion 52R are located at the same position in the first direction and are located at positions separated from each other in the second direction.

In the illustrated example, the bracket 50 is constituted by two separate components. As a result, not only the upper support portions 52L, 52R but also the fixing portions 51 and the connecting portions 53 are two separate components. The fixing portions 51 and/or the connecting portions 53 that are two separate components may be integrated together such that the bracket 50 is integrated as a single component.

The intermediate mount 60 is a member for protecting the battery stacks 30 from a load applied to the battery pack 10 from above. The intermediate mount 60 is provided at a central position of the case 20 in the second direction. The intermediate mount 60 is provided at a position overlapping, in the second direction, a boundary position between the two battery stacks 30 adjacent in the second direction.

Upper support portions 62L, 62R constituting the upper surface of the intermediate mount 60 are located above the upper surface 31 of the battery stack 30. The upper support portions 62L, 62R of the intermediate mount 60 include a one-side upper support portion 62L and an other-side upper support portion 62R located at positions separated from each other in the second direction. The intermediate mount 60 is made of resin (e.g., polyamide).

The intermediate bracket 70 is a member that fixes the battery stacks 30 to each other. The intermediate bracket 70 fixes the two battery stacks 30 adjacent in the second direction. The intermediate bracket 70 is fastened at a total of four points. Two of the four points are fastened to the battery stack 30 on one side in the second direction, and the remaining two points are fastened to the battery stack 30 on the other side in the second direction. The fastening direction is the up-down direction.

The intermediate bracket 70 includes a pair of fastened portions 71 and a top surface portion 72 connecting the fastened portions 71 in the first direction. The top surface portion 72 is located above the fastened portions 71. The top surface portion 72 has a plate shape in which the thickness direction agrees with the up-down direction. The upper surface of the top surface portion 72 is located above the upper surface 31 of the battery stack 30.

The heat insulating member 80 is a member having heat insulating properties (e.g., mica). The heat insulating member 80 includes a body portion 81 and a plurality of (two) upper support portions 82L, 82R. The plurality of (two) upper support portions 82L, 82R is provided at positions different from each other in the second direction. The upper surfaces of the upper support portions 82L, 82R are located above the upper surface 31 of the battery stack 30.

### Functions and Effects

Next, functions and effects of the present embodiment will be described.

As shown in FIG. 1, the present embodiment relates to the battery pack 10. The battery pack 10 includes the battery stacks 30, the voltage monitoring device 40, the bracket 50 that supports the voltage monitoring device 40, and the case 20 that houses these components. The case 20 includes the upper case 22 (see FIG. 2) and the lower case 21. The lower case 21 includes the lower case body 23 and the cross member 24. The battery stacks 30 are disposed to avoid the cross members 24 when viewed from above.

If an attempt is made to increase the ratio of the mounting space for the battery stacks 30 within the case 20, it is difficult to provide, at appropriate positions, the members (intermediate mount or intermediate bracket) for preventing deformation of the upper case 22 due to a load input from above. In the present embodiment, the bracket 50 is fixed to the upper surface portion 24A of the cross member 24, and the upper surface 50A of the bracket 50 is located above the upper surface 31 of the battery stack 30. Therefore, the bracket 50 that supports the voltage monitoring device 40 can serve as the intermediate mount. According to the present embodiment, it is possible to achieve appropriate protection of the battery stacks 30 against the load input from above while securing the mounting space for the battery stacks 30.

In the present embodiment, the bracket 50 is made of metal as shown in FIG. 2. The bracket 50 and the voltage monitoring device 40 are joined by welding, and the bracket 50 and the cross member 24 are fastened by the fastening members 59. Compared to a form in which the bracket 50 is made of resin, the battery stacks 30 can be protected appropriately even if the amount of protrusion from the upper surfaces 31 of the battery stacks 30 (amount of protrusion of the bracket 50) is small. Further, the voltage monitoring device 40 can be supported appropriately and the load can be transmitted effectively to the cross member 24.

In the present embodiment, the cross member 24 extends along the second direction. The upper support portions 52L, 52R constituting the upper surface 50A of the bracket 50 include the one-side upper support portion 52L and the other-side upper support portion 52R. The one-side upper support portion 52L and the other-side upper support portion 52R are located at positions separated from each other in the second direction. Therefore, the bracket 50 for the voltage monitoring device 40 can support the upper case 22 at two points separated from each other in the second direction.

In the present embodiment, the cross member 24 extends along the second direction. Two battery stacks 30 are arranged in the second direction. Therefore, the size of each battery stack 30 can be increased in the second direction compared to a form in which three or more battery stacks 30 are arranged in the second direction. However, the intermediate bracket 70 connecting the battery stacks 30 in the second direction cannot function to suppress deformation of the upper case 22 at a position offset in the second direction from the center of the case 20 in the second direction. In the present embodiment, the battery pack 10 includes the intermediate mount 60 including the upper surfaces 62L, 62R located above the upper surfaces 31 of the battery stacks 30. The bracket 50 or the intermediate mount 60 is located at a position offset in the second direction from the center in the second direction within the case 20. Therefore, the bracket 50 for the voltage monitoring device 40 or the intermediate mount 60 can suppress deformation of the upper case 22 at a position offset in the second direction from the center of the case 20 in the second direction.

In the present embodiment, the bracket 50 is located at a position offset in the second direction from the center in the second direction within the case 20. Therefore, the bracket 50 for the voltage monitoring device 40 can suppress deformation of the upper case 22 at a position offset in the second direction from the center of the case 20 in the second direction. Further, the voltage monitoring device 40 can be disposed at a position offset in the second direction from the center of the case 20 in the second direction.

Although the preferred embodiment of the present disclosure has been described above, the present disclosure is not limited to the above description.

What is claimed is:

1. A battery pack comprising:
a plurality of battery stacks;
a voltage monitoring device;
a bracket that supports the voltage monitoring device; and
a case that houses the battery stacks, the voltage monitoring device, and the bracket, wherein
the case includes an upper case and a lower case,
the lower case includes a lower case body and a cross member,
the battery stacks are disposed to avoid the cross member when viewed from above,
the bracket is fixed to an upper surface portion of the cross member, and
an upper surface of the bracket is located above upper surfaces of the battery stacks.

2. The battery pack according to claim 1, wherein:
the bracket is made of metal;
the bracket and the voltage monitoring device are joined by welding; and
the bracket and the cross member are fastened by a fastening member.

3. The battery pack according to claim 1, wherein:
when directions perpendicular to a vehicle up-down direction and perpendicular to each other are defined as a first direction and a second direction,
the cross member extends along the second direction;
upper support portions constituting the upper surface of the bracket include:
a one-side upper support portion; and
an other-side upper support portion; and
the one-side upper support portion and the other-side upper support portion are located at positions separated from each other in the second direction.

4. The battery pack according to claim 1, wherein:
when directions perpendicular to a vehicle up-down direction and perpendicular to each other are defined as a first direction and a second direction,
the cross member extends along the second direction;
two of the battery stacks are arranged in the second direction;
the battery pack includes an intermediate mount including an upper surface located above the upper surfaces of the battery stacks; and
the bracket or the intermediate mount is located at a position offset in the second direction from a center in the second direction within the case.

5. The battery pack according to claim 1, wherein:
when directions perpendicular to a vehicle up-down direction and perpendicular to each other are defined as a first direction and a second direction,
the cross member extends along the second direction;
two of the battery stacks are arranged in the second direction; and
the bracket is located at a position offset in the second direction from a center in the second direction within the case.
